(19) United States
(12) Patent Application Publication
(10) Pub. No.: US 2019/0047179 A1
(43) Pub. Date: Feb. 14, 2019

(54) MOULDING OF PLASTIC CONTAINERS WITH HANDLES

(71) Applicant: IPET Technologies LTD, Daii, Nicosia (CY)

(72) Inventor: Constantinos Sideris, Strovolos, Nicosia (CY)

(21) Appl. No.: 16/076,392

(22) PCT Filed: Feb. 8, 2017
(86) PCT No.: PCT/EP2017/052779

§ 371 Date: Aug. 8, 2018

(30) Foreign Application Priority Data
Feb. 8, 2016 (GB) 1602242.8

(51) Int. Cl. B29B 11/08; B29B 11/14; B29C 49/06

(52) U.S. Cl. CPC B29B 11/08; B29B 11/14; B29C 2049/2039; B29B 2911/14513; B29C 49/06

(57) ABSTRACT

The production of a container with an integrated handle, by injection moulding a preform with an incorporated handle protrusion, where such protrusion has a direction perpendicular to the axis of the preform and then stretch blow moulding the said preform into a container, where before the end of the blowing step the handle protrusion is deformed into the shape and/or position it will have in the finished container.

The present invention relates to the preforms, the method and the apparatus required for producing plastic containers with integrated handles.

### BACKGROUND

Plastic bottles with integrated handles can be produced by extrusion blow moulding and are widely available. However the raw materials that can be processed with extrusion blow moulding do not have transparency. For transparent containers the plastic of choice is polyethylene terephthalate (PET), which is processed by firstly injection moulding of preforms and secondly stretch blow moulding these preforms into containers. This process cannot be used for the production of containers with integrated handles of the type produced with extrusion blow moulding.

Efforts to design and produce plastic containers with handles, where such containers are transparent and produced by injection and stretch blow moulding, have resulted either in separately moulded handles that are clipped onto the containers after container production or separately moulded handles that are inserted in the blow mould and are thus encapsulated onto the container during blow moulding. Such separately moulded handles are usually from a different raw material than the bottle and present difficulties in recycling. Also such separately moulded handles require one additional production step of moulding the handles and one additional production step to clip or insert the handles, making the production of containers with such handles more costly.

Containers with integrated handles have been developed, but such handles are connected only to the neck part of the container, but not also to the body of the container (U.S. Pat. No. 6,454,110 B1—A K Technical Laboratory). This type of integrated handles are not as convenient to use, in that although they can be used for lifting the full containers in use, they cannot be used for easy pouring of the contents out of the container. In view of the opening and closing direction of the injection moulds that are used to produce the preforms, it is convenient to mould the incorporated handles so that the handles are in a plane that is generally perpendicular to the axis of the preform and container body, as in U.S. Pat. No. 6,454,110 B1. Other handle orientations relative to the preform axis, are not convenient to mould.

For the convenience of being able with only one hand to pour out the contents of a container in use, the handle on the container should be oblong with one end connected towards the upper side of the container near its neck opening, and the other end connected to the body of the container, so that the fingers of the user can pass through the handle for secure holding. Such a handle would then need to have an orientation which is not perpendicular to the axis of the container and preform body, but rather at an angle between parallel and perpendicular (0 and 90 degrees) to this axis. This handle orientation presents technical problems in moulding the preform with such incorporated handle, due to the way the injection mould needs to operate.

Several designs of preforms with incorporated handles have been put forward but without commercial success, mainly due to technical and practical difficulties with the injection mould and production process. One such example was proposed by Limanjaya (WO 01/12515 A1) with a handle oriented at an angle between parallel and perpendicular, which would present moulding difficulties. Other examples are handles moulded parallel with the preform axis, as proposed by Hong-Yeol Kim (US2005/0048237 A1), Pryor (WO96/30189) and Tri-Tech Systems (U.S. Pat. No. 4,629,598). In these three examples the handles are moulded parallel with the preform axis, which although technically possible it is practically very difficult to implement on a production scale due to limitations in the design and operation of the injection moulds.

In the examples of Pryor and Tri-tech, there is provision for very slight flexing of the handles, to give them a very small angle of orientation away from being parallel to the preform axis. In the case of Tri-Tech this is in order to give a ‘pre-load’ for the handle to ‘push’ on the container body so that when in use, the handle will not bend away from the container. In the case of Pryor the slight flexing is proposed in order to improve the encapsulation of the handle in the body of the container during blow moulding, by increasing the distance available for the blown material to wrap around the end of the handle. In neither of the above two examples is the flexing changing the overall shape or orientation of the handle.

All the attempts made so far to produce containers with the injection and stretch-blowing process having integrated handles with the same material as the containers have resulted either in handles that are not very convenient in use because their orientation is perpendicular to the axis of the container or in handles that are impractical to mould.

There is therefore a need for a method and apparatus and associated preforms, for the economical and technically viable production of PET containers with integrated handles, for convenient lifting, handling and pouring.

### SUMMARY OF THE INVENTION

According to a first aspect of the present invention, there is provided a method for producing a container with at least one integrated handle, the method comprising the steps of:

injection moulding a preform comprising a body area, a neck area, and having at least one integrated handle protrusion, wherein a first end of the handle protrusion is connected on or adjacent to the neck area of the preform and a second opposed, free end of the handle protrusion extends outwardly away from the neck such that the handle protrusion extends in a direction extending substantially perpendicular to the body area of the preform; and

stretch blow moulding of the preform into the container, comprising placing the preform within a blow mould at a predetermined temperature; and stretching and blowing the preform inside the blow mould into a container such that the second opposed end of the handle protrusion is encapsulated by the blown body of the container;

wherein at any time between preform moulding and the end of stretch blow moulding, the handle protrusion on the preform is bent or deformed from its initial position to a predetermined shape and position to form the finished container.

The container may have a handle having any suitable shape, for example an oblong handle.
The initial position of the handle protrusion may be a generally horizontal position. For example, the handle protrusion may extend substantially perpendicular to the longitudinal axis of the neck and/or body area of the container.
The predetermined position of the handle protrusion(s) of the finished container may be a slanted or generally vertical position. For example, the predetermined position of the handle protrusion(s) of the finished container may extend in a direction extending substantially parallel to or at an acute angle with respect to the longitudinal axis of the neck and/or body area of the container.
The opposed, free end of the handle protrusion(s) may comprise a structural feature that enables a secure engagement of said opposed, free end of the protrusion to the blown body of the container.
The structural feature may extend at an angle from 90 degrees to 30 degrees relative to the longitudinal axis of the handle

In one embodiment of the present invention, the preforms produced by injection moulding may be removed from the injection mould while still hot at a temperature suitable for stretch-blowing and are transferred directly to the blow mould. In another embodiment the hot preforms first pass through an intermediate step for adjusting the preform temperature for better subsequent stretch blowing, before being placed in the blow mould.

In one embodiment of the present invention, the preforms produced by injection moulding are cooled to room temperature and stored, so that they can later be transferred to another machine where they are re-heated to stretch-blowing temperature and stretch-blown into the required containers.

According to a second aspect of the present invention there is provided a container comprising a neck area and a body area, in which the container further comprises at least one handle protrusion integrated at a first end with a neck area of the container, and integrated at a second end with a body area of the container, in which neck area, body area and handle protrusion are composed of the same material.
The neck area, body area and handle protrusion(s) are preferably composed of PET.
Preferably, the at least one handle protrusion of the container extends in a direction extending substantially parallel to or at an acute angle with respect to the longitudinal axis of the neck and/or body area of the container.

The handles of the containers produced by the method of the present invention are moulded generally perpendicularly to the axis of the preforms, making the moulding process technically viable. Such handle protrusions on the preforms are later deformed to take a new shape and/or orientation, which is convenient for the handling of the bottle.

Preferably, the handle is made from the same material as the preform (and thus the container), making the recycling of the container much easier compared with containers with separately moulded handles of different plastic materials. Preferably, the handle portion and the preform are composed of PET.

This invention provides for a blow mould designed so that it guides and/or holds the deformed handle into its final predetermined position accurately securing it for encapsulation in the blown body of the container. A person familiar with the art of blow mould design and manufacture can arrange for the required blow mould design.

Preferably, there is one or more mechanisms for deforming the handle protrusion on the preform, to take a position where it can be encapsulated by the blown material forming the body of the container. A person familiar with the art of design and manufacture of automation or robotics, can arrange for such required mechanisms.

According to one embodiment, the handle deforming mechanism(s) is partially or wholly incorporated in the blow mould, while in other embodiments the handle deforming mechanism(s) is partially or wholly independent from the blow mould.

In one embodiment of the invention a preform is provided, which incorporates a generally straight handle protrusion. The handle protrusion may be relatively thin so that it possesses flexibility in order for its shape to flex into a completely different shape and into the orientation it will take in the container, by the forces applied by the deforming mechanism(s).

In another embodiment of the invention a preform is provided, which incorporates a rigid handle for higher strength. At a connection point between the handle and the neck area of the preform there is a small thin area, which is capable of flexing sufficiently to act as a pivot around which the handle will be rotated by the forces applied by the deforming mechanism(s), to take its final predetermined position as it will be in the container.

In yet another embodiment of his invention, where the preform may be taken directly from the injection mould while still warm, to the blow mould for stretch blow moulding, the handle as moulded in the preform is rigid for higher strength, but at the connection point between the handle and the neck area of the preform there is a small thick area, which retains heat and is therefore soft, so that it acts as a pivot around which the handle will be rotated by the forces applied by the deforming mechanism(s), to take its final position as it will be in the container.

According to a further aspect of the present invention, there is provided a container formed from a preform for blow moulding, wherein said preform comprises at least one incorporated handle protrusions, and wherein the handles of the container extend substantially perpendicular to the axis of the handle protrusion(s) of the preform.

According to a further aspect of the present invention, there is provided an apparatus for the production of plastic containers with integrated handles, in which the apparatus comprises:

injection moulding apparatus for preforms with incorporated handle protrusions;
temperature control apparatus arranged in use to adjust preform temperature and/or to re-heat preforms to stretch-blowing temperature;
apparatus arranged in use to place preforms in the blow moulds. apparatus for deforming the handle protrusion into the predetermined shape and orientation of the container;
apparatus for stretching and blowing the preform inside the blow mould into a container, in a manner that the end of the handle protrusion is encapsulated by the blown body of the container.
Examples of suitable injection moulding apparatus include, but are not limited to injection moulding means, injection moulds and post-mould cooling apparatus. In one embodiment, the apparatus for stretching and blowing of the preform may be arranged to wrap around the end of the handle during blowing.

The apparatus may include one or more mechanisms for deforming the handle protrusion into the shape and position for stretch blowing, which mechanism(s) can be partially or wholly incorporated in the blow mould, or mounted on or near the blow mould. The blow mould design may include parts that serve to partially guide the handle protrusion into its final position or shape and/or parts to hold the handle in that position or shape to prevent it from moving during blowing.

In another embodiment the invention can be implemented with the preforms having two handle protrusions on opposite sides of their neck area and the deforming mechanisms being capable of deforming both handle protrusions, so that the container produced will have two handles.

The present invention includes the apparatus for implementing the above production method, and in particular the one or more mechanism(s) for the handle deformation.

According to a further aspect, the present invention provides a preform for blow moulding a plastics container, wherein said preform comprises at least one incorporated handle protrusions, wherein said protrusion(s) extend in a direction extending substantially perpendicular to the axis of the preform, and wherein said preform is stretch blow moulded into a container wherein before the end of the blowing step the handle protrusion(s) is deformed into a predetermined shape and/or position for the finished container.

The containers of the present invention are formed with the handle incorporated as they are delivered from the production machine. As result, there is no requirement for additional processing steps to attach the handles, saving production costs.

The containers of the present invention have the advantage that the handles on the produced containers can be very rigid for secure handling of bigger sized containers that are heavy when filled.

The containers of the present invention are economical because the weight of the handle can be less than the corresponding weight of separately moulded handles of equal strength, thus saving raw material costs.

The handles of the containers may be long enough and with a contoured shape for comfortable fit of the fingers, for convenient container handling during use.

In contrast to clip-on separately moulded handles, the handles of the produced containers have no possibility to detach from the container, adding to the safety of the container in use.

### BRIEF DESCRIPTION OF THE DRAWINGS

The invention can be performed in various ways and, by way of example only, specific embodiments thereof will now be described, reference being made to the accompanying drawings.

FIGS. 1a to 1c illustrate the design of a bottle according to a first embodiment of the present invention in which the bottle comprises an integrated handle protrusion and the corresponding preform from which the bottle can be stretch blow moulded;

FIG. 2 illustrates the design of a bottle according to a second embodiment of the present invention in which the bottle comprises an alternative, stronger integrated handle and the corresponding preform from which the bottle can be stretch blow moulded;

FIGS. 3a and 3b illustrate two alternative embodiments of the method of the present invention for deforming a rigid handle on a preform from an initial position into a predetermined final position before blow moulding;

FIGS. 4a and 4b illustrate a number of different shapes and orientations that the handle protrusions can be bent and/or deformed to, adopting to various container designs; and

FIG. 5 illustrates a design of a bottle according to a further embodiment of the present invention and demonstrates the deformation of a handle portion during formation of the bottle.

### DESCRIPTION OF PREFERRED EMBODIMENTS

In the arrangements described below a container consists of a neck area 1, a body 2 and a handle 3. The corresponding preform has a neck area 1a, which is identical to the neck area 1 of the container, as this area is not affected by the stretch-blowing of the preform into the container. The preform also has its main body 4 and a handle portion 5 protruding outwards from its neck area 1a.

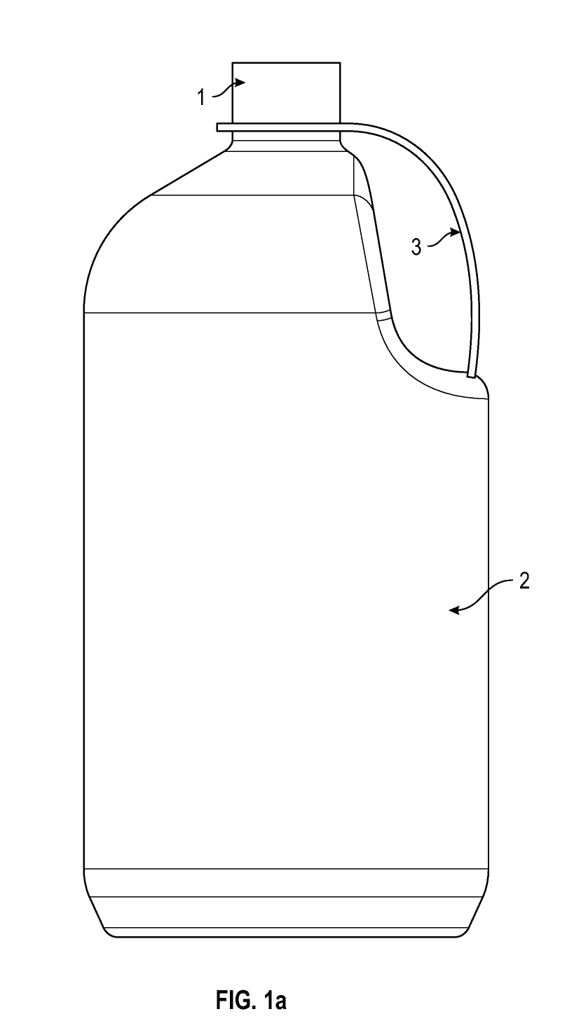

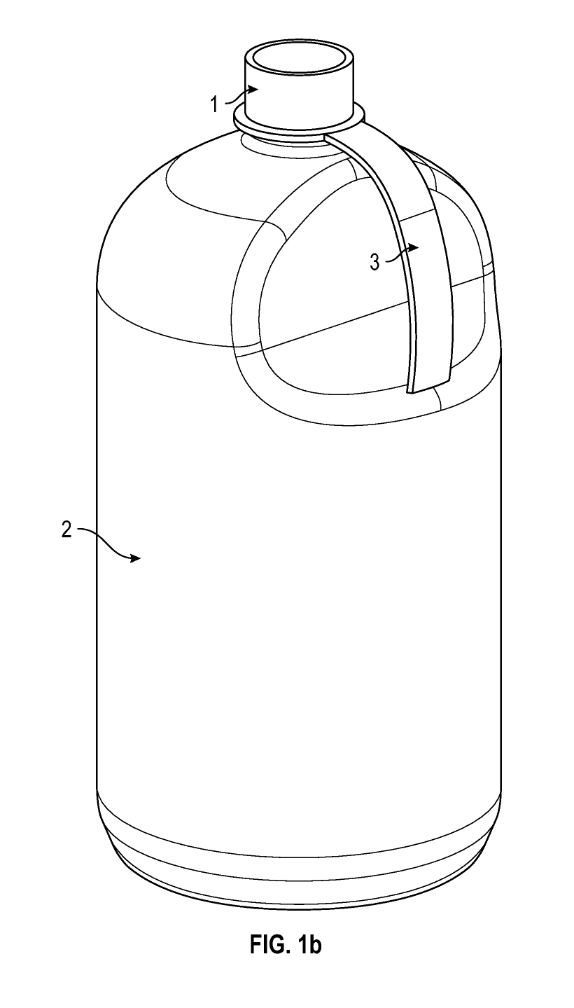

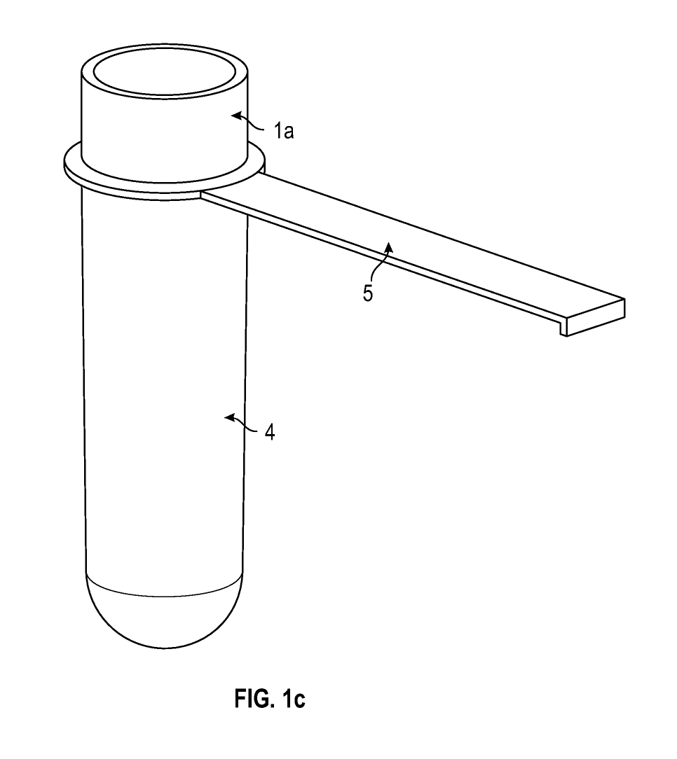

One such preferred arrangement is illustrated in FIG. 1, in which FIG. 1a illustrates in side view the overall shape of a container with the incorporated handle 3, FIG. 1b illustrates in isometric view the same container and FIG. 1c illustrates in isometric view the preform that can be used to produce this container, with the integrated handle protrusion 5.

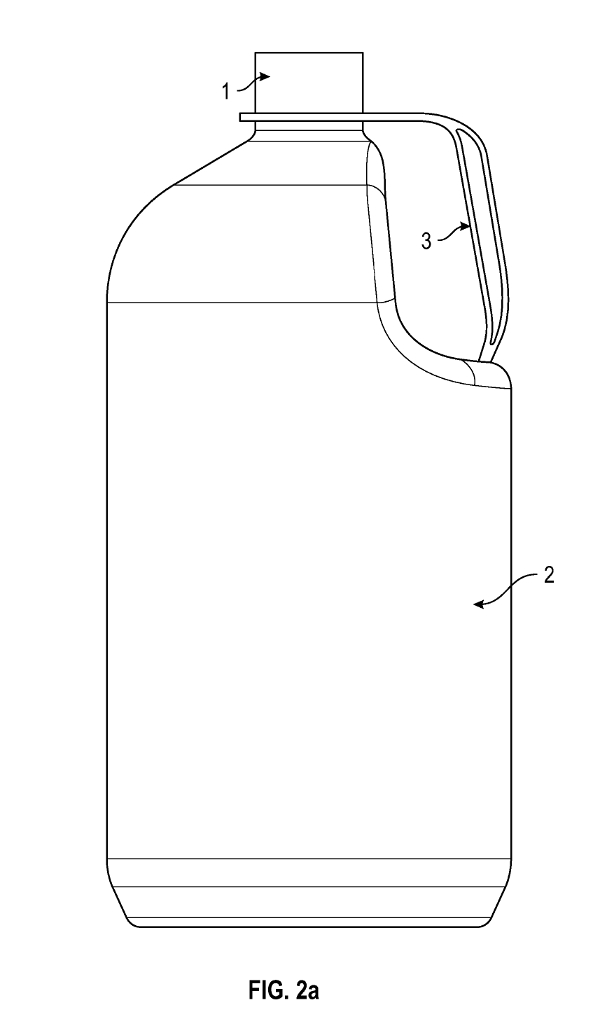

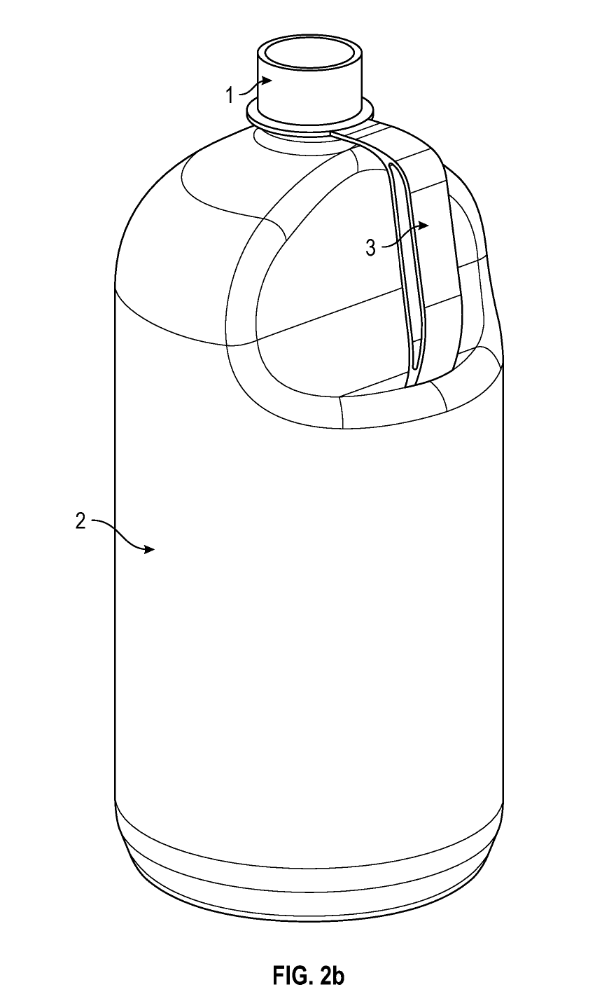

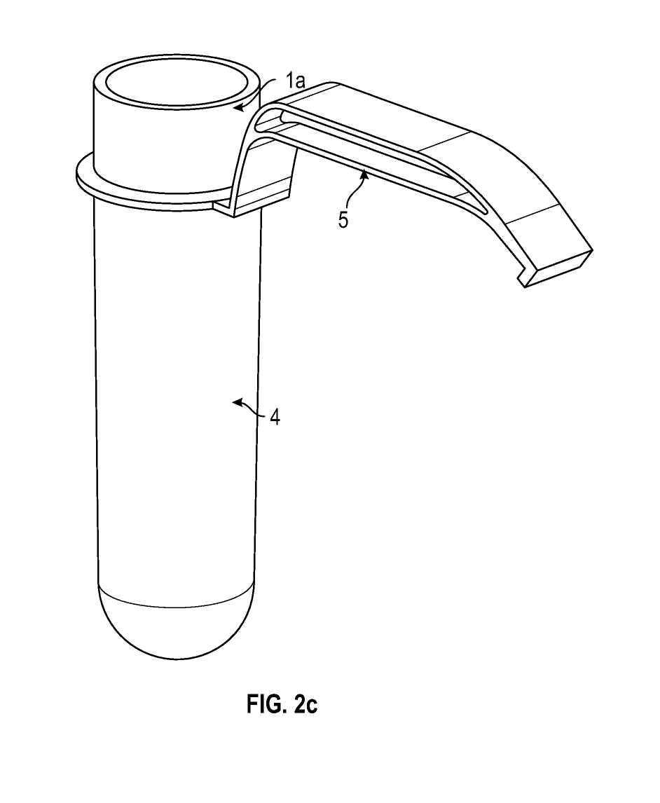

Another preferred arrangement is illustrated in FIG. 2, in which FIG. 2a illustrates in side view the overall shape of a container with a rigid, stronger incorporated handle 3. FIG. 2b illustrates in isometric view the same container and FIG. 2c illustrates in isometric view the preform that can be used to produce this container, with the rigid, stronger integrated handle protrusion 5.

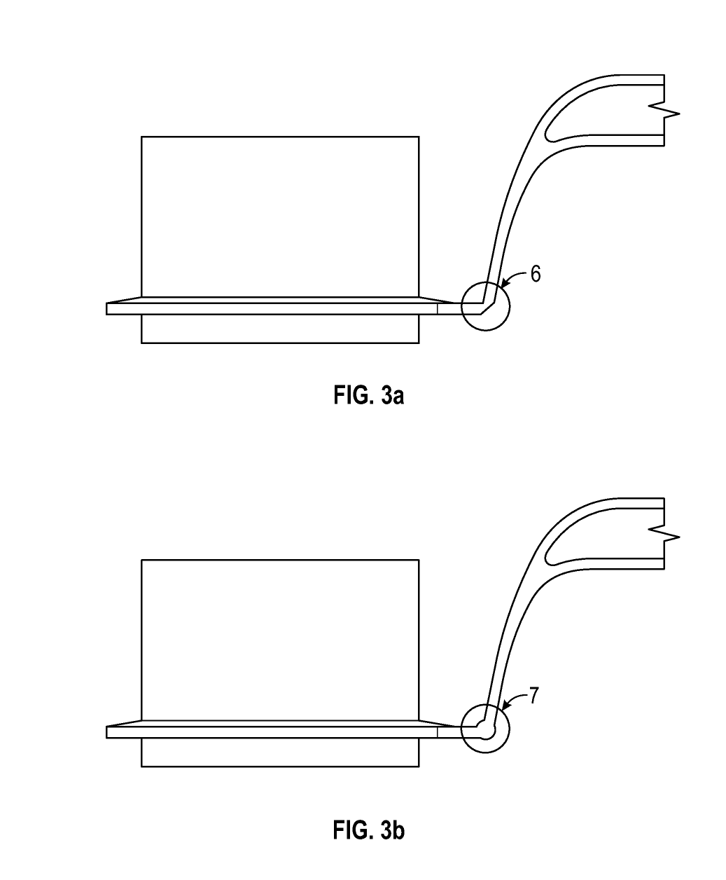

FIG. 3 illustrates two alternative designs of a preform with a rigid, strong handle, each alternative being suitable for a different way in which the bending or deformation of the handle to its final position in the blow mould can occur. In FIG. 3a there is a thin area 6, where the handle portion 5 is connected to the neck area 1a of the preform, placed at the place where the handle portion 5 should pivot when deformed to its final blowing position. Being a thin area 6, it is the weakest mechanically and will deform when a force is applied to move the handle portion 5, acting as a pivot around which the handle portion 5 will rotate. In FIG. 3b there is a thick area 7, where the handle portion 5 is connected to the neck area 1a of the preform, placed at the place where the handle portion 5 should pivot when moved to its blowing position. Being a thick area, in the cases where the preform is removed still hot from the injection mould so that it can be taken directly (or via a temperature adjustment step) to the blow mould for stretch-blowing, this thick area retains more heat and is therefore hotter and softer, so it is the weakest point and will deform when a force is applied to move the handle portion 5, acting as a pivot around which the handle portion 5 will rotate.

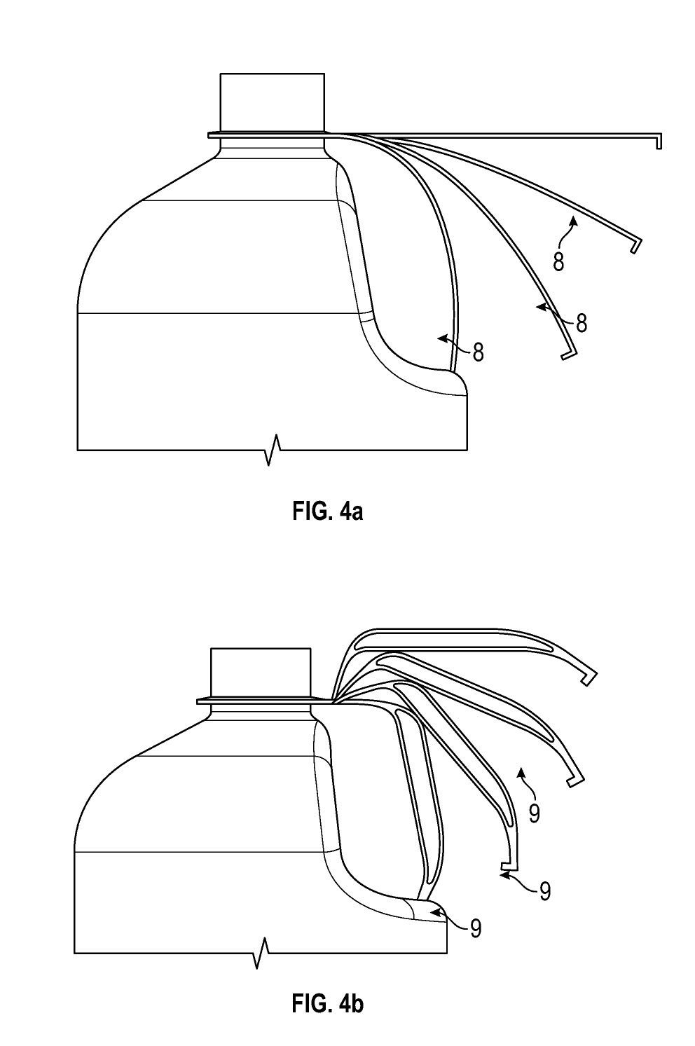

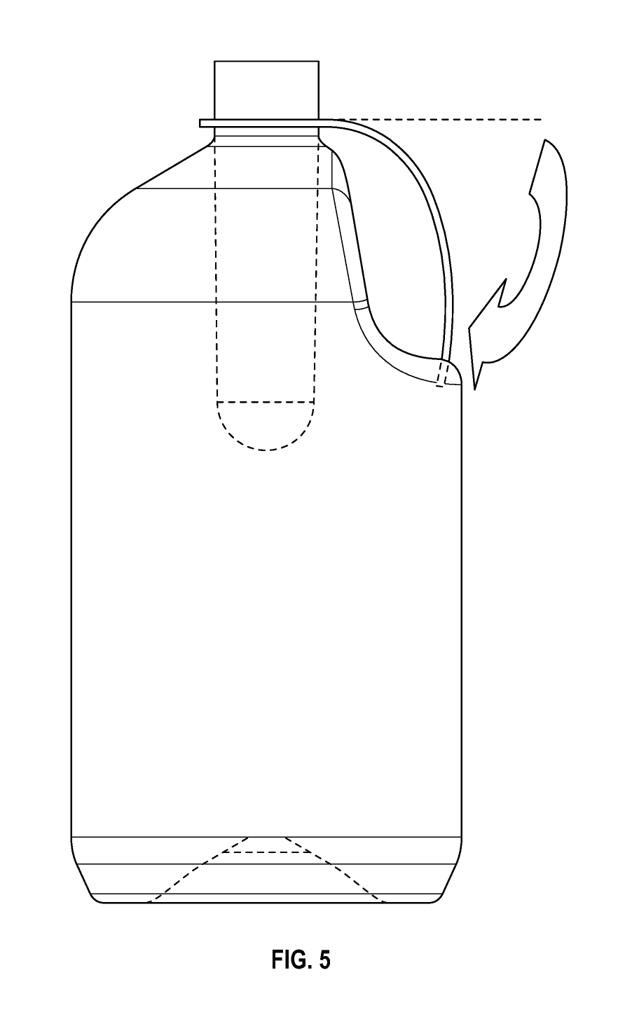

FIG. 4 illustrates the way in which the handle portions 5, as moulded on the preforms, can be deformed or bent, in order to take the final shape and position required, depending on the design of the container to be produced. FIG. 4a illustrates possible deformations 8 of a handle portion 5 similar to the one in FIG. 1, where this handle portion 5 is relatively thin and flexible so that it can be bent into shape by one or more deforming mechanism(s). The final shape and position of such a handle 3 can be determined mainly by the deforming mechanism(s) as well as by the design of the handle portion 5 as moulded on the preform and each handle position will also require a different container design for encapsulating the end of the handle portion 5. This invention provides for the flexibility of handle design in size, shape and orientation, allowing a big variety of possible bottle designs.

FIG. 4b illustrates possible deformations 9 of a handle portion 5 similar to the one in FIG. 2, where this handle portion 5 is rigid and strong and cannot be deformed in the way similar to the handle portion 5 of FIG. 4a. Instead this rigid handle portion 5 can be rotated about a pivoting point by the deforming mechanism(s), to any angle that is required by the design of the container, allowing flexibility in size, shape and orientation of the handle. Such a pivoting point can operate as described in FIG. 3.

The handle protrusions incorporated on the preforms, may be designed with features that make it easier for the deforming mechanism(s) to deform them reliably and/or features that help in the possible guiding and holding the handle protrusions securely in place during blowing and/or features that allow for a secure encapsulation of the end of the handle into the body of the container by the body wrapping around such features for preventing possible removal of the handle end from the container body.

1. A preform for blow moulding a plastics container, wherein said preform comprises a body area, a neck area, and at least one incorporated deformable handle protrusion,
wherein a first end of the handle protrusion is connected on or adjacent to the neck area of the preform comprising a connection point and a second opposed, free end of the handle protrusion(s) extends outwardly away from the neck such that in an initial position the handle protrusion extends in a direction extending substantially perpendicular to the longitudinal axis of the body area of the preform, and
wherein the second opposed, free end of the handle protrusion(s) comprises a structural feature that enables a secure engagement of the second opposed, free end of the protrusion to the blown body of the container, and
wherein said preform is stretch blow moulded into a container and wherein the handle protrusion(s) is deformable around the connection point into a final predetermined position substantially parallel to or at an acute angle to the longitudinal axis of the body area of the container before the end of the blowing step.

2. The preform of claim 1, wherein said handle protrusion(s) is made from the same material as the preform and produced as an integral member with the preform during injection moulding of the preform.

3. The preform of claim 2, in which the handle protrusion(s) and preform are composed of PET.

4. The preform of claim 1, wherein said handle protrusion(s) is substantially linear in shape, and relatively thin so that it possesses sufficient flexibility in order for it to be deformed from an initial position to a predetermined final position during formation of the container.

5. The preform of claim 1, wherein said handle protrusion(s) is rigid for higher strength, and wherein flexing is possible at the connection point between the handle and the neck area of the preform, said flexing is achieved by the presence of a small thin area, wherein said thin area can flex to act as a pivot around which the handle will be rotated, to take its final position as it will be in the container.

6. The preform of claim 1, in which the structural feature extends at an angle from 90 degrees to 30 degrees relative to the longitudinal axis of the handle.

7. The preform of claim 1, comprising two handle protrusions on opposite sides of their neck area, wherein both of said handle protrusions are deformable so that they can be encapsulated by the blown body of the container so that the container produced will have two handles.

8. The preform of claim 1, wherein the handle comprises a region of increased thickness, at a point between the connection between the handle and the neck area of the preform, and wherein the region of increased thickness retains heat from injection moulding prior to blow moulding such that the region of increased thickness acts as a pivot point around which the handle will be rotated to take its final position as it will be in the container.

9. A method for producing a container with at least one integrated handle, the method comprising the steps of:
injection moulding a preform as claimed in claim 1; and
stretch blow moulding of the preform into the container, comprising placing the preform within a blow mould at a predetermined temperature; and stretching and blowing the preform inside the blow mould into a container such that the second opposed, free end of the handle protrusion is encapsulated by the blown body of the container;
wherein at any time between preform moulding and the end of stretch blow moulding, the handle protrusion on the preform is bent or deformed from its initial position to a predetermined shape and position to form the finished container.

10. The method according to claim 9 wherein preforms are transferred for blow moulding while sufficiently warm such that sufficient heat is retained in an area of increased thickness of the section of the handle protrusion, said area in its warm state being the point of weakness thus enabling the handle protrusion to deform easily at that point.

11. An apparatus for the production of plastic containers with integrated handles, in which the apparatus comprises:
injection moulding apparatus for preforms with incorporated handle protrusions as claimed in claim 1;
temperature control apparatus arranged in use to adjust preform temperature and/or to re-heat preforms to stretch-blowing temperature;
apparatus arranged in use to place preforms in the blow moulds.
apparatus for deforming the handle protrusion of the preform into the predetermined shape and orientation of the container; and
apparatus for stretching and blowing the preform inside the blow mould into a container, in a manner that the second opposed, free end of the handle protrusion is encapsulated by the blown body of the container.

12. A blow mould for enabling the production of bottles from a preform with at least one incorporated handle protrusions as claimed in claim 1, wherein said handle protrusion(s) are deformed before the final stages of blow moulding, said mould comprising at least one handle deforming mechanism.

13. The blow mould of claim 12 wherein said handle deforming mechanism is partially or wholly incorporated in the blow mould.

14. The blow mould according to claim 12 wherein said handle deforming mechanism is partially or wholly independent from the blow mould.

15. The blow mould of claim 12 comprising guides that guide the deformed handle from an initial position into its final predetermined position for encapsulation in the blown body of the container.

16. The blow mould of claim 15 further comprising a hold mechanism that holds the deformed handle in its final predetermined position, and accurately securing said handle(s) for encapsulation in the blown body of the container.
